(19) United States
(12) Patent Application Publication
(10) Pub. No.: US 2025/0276547 A1
(43) Pub. Date: Sep. 4, 2025

(54) TIRE

(71) Applicant: Sumitomo Rubber Industries, Ltd., Kobe-shi (JP)

(72) Inventors: Yu HASHIMOTO, Kobe-shi (JP); Yoshifumi KAWAGOE, Kobe-shi (JP); Kohei IKEDA, Kobe-shi (JP)

(73) Assignee: Sumitomo Rubber Industries, Ltd., Kobe-shi (JP)

(21) Appl. No.: 19/044,342

(22) Filed: Feb. 3, 2025

(30) Foreign Application Priority Data
Mar. 1, 2024 (JP) 2024-031596

(51) Int. Cl. B60C 11/03; B60C 11/12

(52) U.S. Cl. CPC B60C 11/0306; B60C 11/0304; B60C 11/12; B60C 2011/0341

(57) ABSTRACT

A tire has a tread portion including a middle land portion defined between a crown circumferential groove and a shoulder circumferential groove. The middle land portion is provided with communicating sipes, axially inner sipes and axially outer sipes. The communicating sipes include a first communicating sipe comprising a first linear portion extending from the crown circumferential groove, and a first curved portion extending from an end of the first linear portion to the shoulder circumferential groove in a curved manner.

### TECHNICAL FIELD

The present disclosure relates to a tire.

### BACKGROUND ART

Patent Document 1 listed below discloses a tire in which a land portion of the tread portion is provided with linearly-extending first and second inclined sipes, and the first and second inclined sipes are each provided with a deep bottom portion and a shallow bottom portion in hopes of being improved in steering stability on dry road surfaces and on-snow/ice performance.
Patent Document 1: Japanese Patent Application Publication No. 2022-064106

### SUMMARY OF THE INVENTION

### Problems to be Solved by the Invention

In recent years, since performances of the automobile have been improved, the tires are also required to be further improved in performance on snowy and icy roads. As shown in Patent Document 1, sipes extending linearly over the entire lengths, tend to generate frictional force only in a specific direction. Therefore, there is a need to improve cornering performance (especially steering responsiveness) on snowy and icy roads.

On the other hand, even in tires designed for driving on snowy and icy roads, it is necessary to maintain the travelling performance on dry roads (hereinafter, simply referred to as the “dry performance”).

The present disclosure was therefore, made in view of the above circumstances, and a primary objective of the present disclosure is to provide a tire which can exert excellent on-snow/ice performance while maintaining dry performance.

### Means for Solving the Problems

According to the present disclosure, a tire comprises a tread portion comprising a plurality of circumferential grooves extending continuously in the tire circumferential direction, and a plurality of land portions axially divided by the plurality of circumferential grooves,

wherein
the circumferential grooves include a crown circumferential groove, and a shoulder circumferential groove disposed axially outside the crown circumferential groove adjacently thereto,
the land portions include a middle land portion disposed between the crown circumferential groove and the shoulder circumferential groove,
the middle land portion is provided with a plurality of communicating sipes extending from the crown circumferential groove to the shoulder circumferential groove. a plurality of inner sipes extending axially outwards from the crown circumferential groove and terminated without reaching the shoulder circumferential groove, and a plurality of outer sipes extending axially inwards from the shoulder circumferential groove and terminated without reaching the crown circumferential groove, and
the communicating sipes include a plurality of first communicating sipes each comprising a first linear portion extending linearly axially outward from the crown circumferential groove, and a first curved portion extending curvedly from an axially outer end of the first linear portion toward the shoulder circumferential groove.

### Effects of the Invention

In the present disclosure, by adopting the above configuration, the tire is able to demonstrate excellent on-snow/ice performance while maintaining dry performance.

### BRIEF DESCRIPTION OF THE DRAWINGS

FIG. 1 is a developed partial view of a tread portion of a tire as an embodiment of the present disclosure.

FIG. 2 is a top view of a part of the middle land portion of the tire shown in FIG. 1.

FIG. 3 is an enlarged view showing the first communicating sipe and its surroundings in FIG. 2.

FIG. 4 is an enlarged view showing a second communicating sipe and its surroundings in FIG. 2.

FIG. 5 is a cross-sectional view taken along line A-A in FIG. 3.

FIG. 6 is a top view of a part of the crown land portion of the tire shown in FIG. 1.

FIG. 7 is a cross-sectional view taken along line B-B in FIG. 6.

FIG. 8 is a top view of a part of the shoulder land portion of the tire shown in FIG. 1.

FIG. 9 is a developed partial view of a tread portion of a comparative example tire.

### DETAILED DESCRIPTION OF THE INVENTION

Hereinafter, an embodiment of the present disclosure will be described in detail in conjunction with accompanying drawings.

Incidentally, in order to facilitate understanding of the present disclosure, the drawings may include exaggerations and dimensional proportions which differ from reality.

The present disclosure can be suitably applied to pneumatic tires although it can be applied to non-pneumatic tires. Taking a pneumatic tire as example the present disclosure will be described.

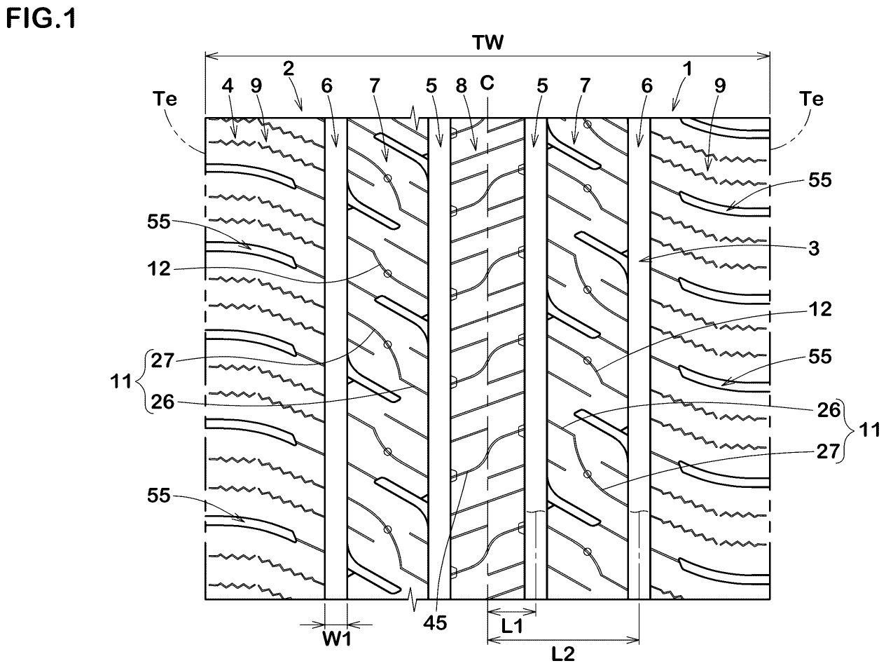

FIG. 1 shows a tread portion 2 of a pneumatic tire 1 as an embodiment of the present disclosure.

In the present embodiment, the tire 1 is designed as a winter tire for passenger cars.

As shown in FIG. 1, the tread portion 2 is provided, between its tread edges Te, with a plurality of circumferential grooves 3 extending continuously in the tire circumferential direction, and a plurality of land portions 4 axially divided by the circumferential grooves 3.

The tread edges Te are the axial outermost edges of the ground contacting patch of the tire which occurs when the tire under a standard state is placed on a flat horizontal plane at a camber angle of 0 degrees and loaded with 70% of a standard load.

In the case that, as in the present embodiment, the tire 1 is a type of pneumatic tire for which various standards have been established, the standard state is a state of the tire which is mounted on a standard wheel rim and inflated to a standard inner pressure but loaded with no tire load.

In the case that the tire 1 is a tire for which various standards are not yet established, the “standard state” means a standard usage state depending on the purpose of use of the tire and in a condition in which the tire is not attached to a vehicle and no tire load is applied.

In this application, dimensions and positions of each part or portion of the tire refer to those under the standard state unless otherwise noted.

The “standard wheel rim” is a wheel rim specified for the tire in a standard system including standards on which the tire is based, for example, the “Standard rim” in JATMA, “Design Rim” in TRA, “Measuring Rim” in ETRTO.

The “standard inner pressure” is the air pressure specified for the tire in a standard system including standards on which the tire is based, for example, the “maximum air pressure” in JATMA, “INFLATION PRESSURE” in ETRTO, and the maximum air pressure listed in the table “TIRE LOAD LIMITS AT VARIOUS COLD INFLATION PRESSURES” in TRA.

In the case that, the tire 1 is a type of pneumatic tire for which various standards have been established, the “standard load” is the load specified for the tire in a standard system including standards on which the tire is based, for example, the “maximum load capacity” in JATMA, “LOAD CAPACITY” in ETRTO, and the maximum tire load listed in the table “TIRE LOAD LIMITS AT VARIOUS COLD INFLATION PRESSURES” in TRA.

In the case that the tire 1 is a tire for which various standards are not yet established, the “standard load” refers to the maximum load which can be applied when the tire is used under the standard usage state, for example, as specified by the tire manufacturer.

In the present embodiment, the circumferential grooves 3 include two crown circumferential grooves 5 and two shoulder circumferential grooves 6.

The two shoulder circumferential grooves 6 are disposed one on each side of the tire equator C.

The two crown circumferential grooves 5 are disposed one on each side of the tire equator C, between the two shoulder circumferential grooves 6.

The distance L1 in the tire axial direction from the groove center line of each crown circumferential groove 5 to the tire equator C is, for example, set in a range from 5% to 15% of the tread width TW.

The distance L2 in the tire axial direction from the groove center line of each shoulder circumferential groove 6 to the tire equator C is, for example, set in a range from 20% to 35% of the tread width TW.

Incidentally, the tread width TW is the distance in the tire axial direction between the two tread edges Te measured under the standard state.

In the present embodiment, the circumferential grooves 3 extend linearly in parallel to the tire circumferential direction.

The groove width W1 of each circumferential groove 3 in this example is 3.0 mm or more. It is preferable that the groove width W1 of each circumferential groove 3 in this example is set in a range from 3.0% to 6.0% of the tread width TW.

The depth (not shown) of each circumferential groove 3 in this example is 5.0 to 15.0 mm. When a numerical range of a parameter such as groove width, depth or the like is described in this specification, the numerical range may be applied to the average value of such parameter.

The land portions 4 include middle land portions 7. The middle land portion 7 is defined between the axially adjacent crown circumferential groove 5 and shoulder circumferential groove 6.

In the present embodiment, two middle land portions 7 are provided so as to locate one on each side of the tire equator C.

In the present embodiment, the land portions 4 further include two shoulder land portions 9 and one crown land portion 8.

The shoulder land portions 9 are axially divided by the respective shoulder circumferential grooves 6 and located axially outside the respective shoulder circumferential grooves 6 so as to include the tread edges Te, respectively.

The crown land portion 8 is defined between the two crown circumferential grooves 5. The crown land portion 8 is positioned on the tire equator C. The crown land portion 8 is adjacent to the middle land portions 7 on both sides thereof via the crown circumferential grooves 5.

In the present embodiment, the tread portion 2 is provided with a tread pattern which is point symmetrical with respect to a point on the tire equator C. Therefore, the features described for one middle land portion 7 can also be applied to the other middle land portion 7. The same applies to the two shoulder land portions 9.

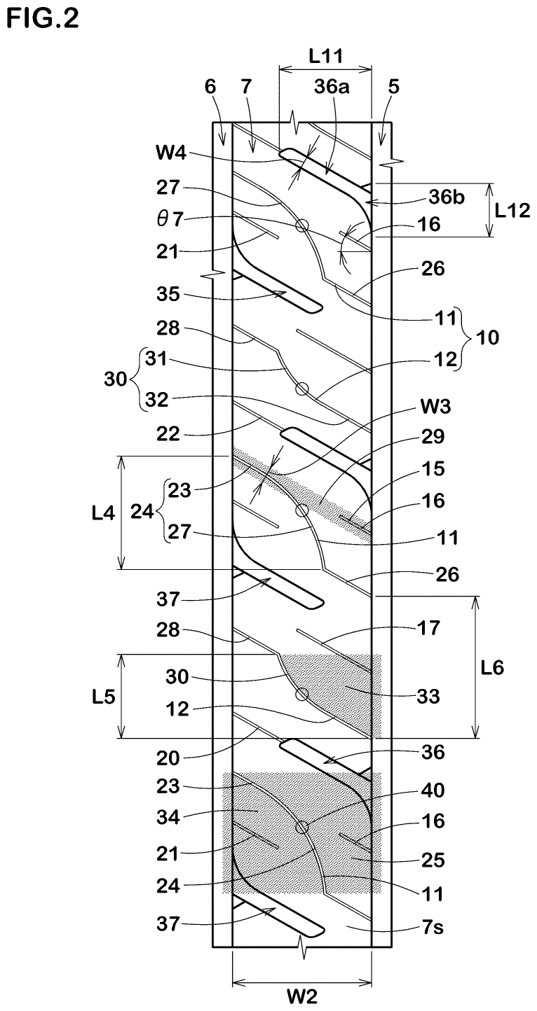

FIG. 2 shows a top view of a part of one of the middle land portions 7 shown in FIG. 1.

As shown in FIG. 2, the middle land portion 7 is provided with a plurality of communicating sipes 10, a plurality of axially inner sipes 15, and a plurality of axially outer sipes 20.

In this application, unless otherwise noted, the term “sipe” means a cut having no substantial width or a very narrow groove whose two opposite walls come into contact with each other when ground pressure is applied to the surrounding portion of the sipe of a land portion and thereby can maintain apparent stiffens of the land portion.

In the present embodiment, the above-mentioned and after-mentioned sipes are those having substantially constant widths from their open tops to bottoms.

In the present disclosure, however, a sipe may be provided with a variable width as far as the sipe has a main portion in which the two opposite walls extend in the tire radial direction in substantially parallel to each other (for example, with the angle difference of less than 10 degrees), and the width between the two opposite sipe walls is 1.5 mm or less, preferably 0.4 to 1.2 mm, more preferably 0.4 to 1.0 mm.

In this case, the sipe may be provided with a chamfer to one of or each of the sipe edges and/or a widened part in the bottom portion of the sipe.

In this application, unless otherwise noted, the term “groove” means a groove in which the opposite groove walls do not come into contact with each other even when ground pressure is applied and which can maintain a substantial drainage path, and in that sense it refers to a groove having a width of 2.0 mm or more.

The communicating sipe 10 is a sipe extending from the crown circumferential groove 5 to the adjacent shoulder circumferential groove 6.

The axially inner sipe 15 is a sipe which communicates with the crown circumferential groove 5 and extends in the tire axial direction, but does not communicate with the shoulder circumferential groove 6.

The axially outer sipe 20 is a sipe which communicates with the shoulder circumferential groove 6 and extends in the tire axial direction, but does not communicate with the crown circumferential groove 5.

Here, the expression “the sipe communicates with the circumferential groove” includes a case in which a space constituting another groove or recess is interposed between the end of the sipe and the circumferential groove. In this case, the length of the space in the tire axial direction is required to be 5 mm or less.

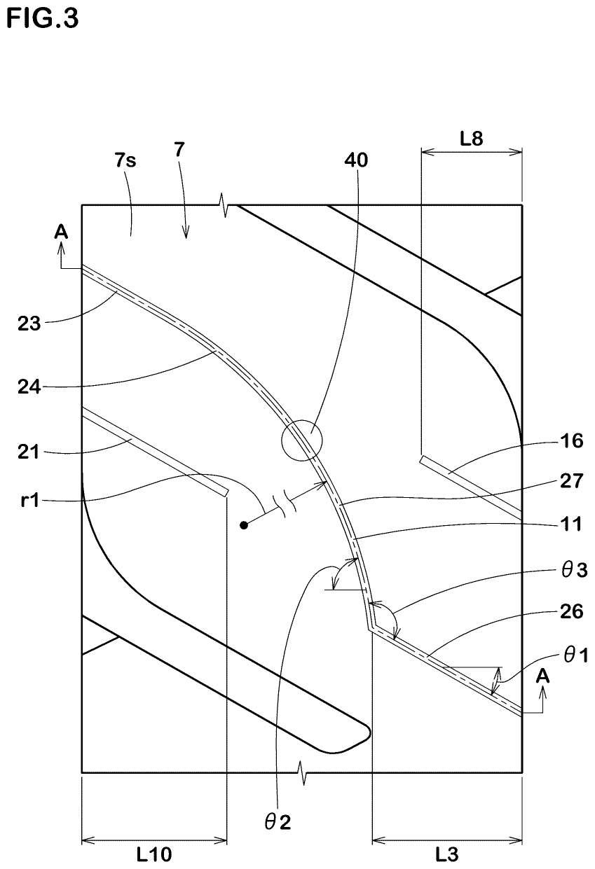

The communicating sipes 10 include a plurality of first communicating sipes 11. FIG. 3 shows the first communicating sipe 11 and its surroundings.

As shown in FIGS. 2 and 3, each of the first communicating sipes 11 comprises
a first linear portion 26 extending linearly from the crown circumferential groove 5, and
an axially outer portion 24 extending from the axially outer end of the first linear portion 26 to the shoulder circumferential groove 6.

Further, the axially outer portion 24 comprises a first curved portion 27 which curves and extends from the axially outer end of the first linear portion 26 toward the shoulder circumferential groove 6.

By adopting the above configurations, the tire 1 according to the present disclosure can exhibit excellent on-snow/ice performance while maintaining dry performance. The reason is as follows.

In the tire 1 according to the present disclosure, as shown in FIG. 2, the middle land portion 7 is provided with the communicating sipes 10, the axially outer sipes 20 and the axially inner sipes 15, as described above. These sipes cam provide frictional forces on snowy and icy roads.

Further, the axially outer sipes 20 and axially inner sipes 15 can prevent the middle land portion 7 from excessive decreasing in rigidity, and help to maintain dry performance.

Further, in the present disclosure, as shown in FIG. 3, the first communicating sipe 11 comprises the first linear portion 26 and the first curved portion 27.

The first linear portion 26 helps to improve the traction performance on snowy and icy roads.

The first curved portion 27 provides frictional forces in multiple directions. Therefore, steering response on snowy and icy roads is improved.

As a result, cornering performance on snowy and icy roads can be improved.

Due to such mechanism, the tire according to the present disclosure can exhibit excellent on-snow/ice performance while maintaining dry performance.

Hereinafter, more detail of the present embodiment will be described.

Described below are specific configurations of the present embodiment. Thus, even if the tire does not include the specific configurations described below, the present disclosure may exert the above-mentioned effects.

If any one of the configurations described below is applied independently to the tire of the present disclosure having the above-mentioned configurations, an improvement of the performance according to each additional configuration can be expected.

Further, when some of the configurations described below are applied in combination, improvements of respective performances based on the applied configurations can be expected.

The first linear portion 26 is, for example, inclined at an angle θ1 with respect to the tire axial direction.

The angle θ1 is, for example, 10 to 50 degrees, preferably 25 to 35 degrees.

The dimension L3 of the first linear portion 26 in the tire axial direction is, for example, 25% to 40% of the width W2 (shown in FIG. 2) in the tire axial direction of the ground contacting top surface of the middle land portion 7.

Thereby, the traction performance on snowy and icy roads can be reliably improved.

The first curved portion 27 is a portion of which angle θ2 with respect to the tire axial direction continuously changes from its end on the first linear portion 26 side toward the shoulder circumferential groove 6.

In the present embodiment, the first curved portion 27 has a shape of a circular arc with a single radius of curvature r1. But, the first curved portion 27 is not limited to such a shape. The radius of curvature r1 is, for example, 30 to 50 mm, preferably 33 to 40 mm.

In the present embodiment, the first communicating sipe 11 is bent at an angle θ3 between the first linear portion 26 and the first curved portion 27.

In the present embodiment, the first linear portion 26 is inclined to one side in the tire circumferential direction toward the outside in the tire axial direction (inclining upward to the left in FIG. 3), and
the first curved portion 27 continued therefrom is curved convexly in an oblique direction (in the upper right direction in FIG. 3) which is toward both the inside in the tire axial direction and the above-said one side in the tire circumferential direction.

As a result, the angle θ2 of the first curved portion 27 with respect to the tire axial direction decreases from its end on the first linear portion 26 side toward the shoulder circumferential groove 6.

The range of change of the angle θ2 is, for example, 25 to 75 degrees.

The angle θ3 between the first linear portion 26 and the first curved portion 27 is, for example, 90 to 160 degrees, preferably 130 to 140 degrees.

Such first communicating sipe 11, when in a state where the two sipe walls are in contact with each other, can effectively suppress shear deformation of the middle land portion 7 and can reliably maintain dry performance.

It is preferable that the first curved portion 27 extends across the center in the tire axial direction of the ground contacting top surface of the middle land portion 7. Thus, the first curved portion 27 is formed over a wide range of the middle land portion 7, and thereby, the steering response on snowy and icy roads is further improved.

In the present embodiment, the axially outer portion 24 comprises a short linear portion 23 which extends linearly from the first curved portion 27 to the shoulder circumferential groove 6.

In the present disclosure, however, the axially outer portion 24 is not limited to such configuration, and it may be composed of only the first curved portion 27 extending from the first linear portion 26 to the shoulder circumferential groove 6.

In the present embodiment, as shown in FIG. 2, the communicating sipes 10 include a plurality of second communicating sipes 12.

In the middle land portion 7 in the present embodiment, the first communicating sipes 11 and the second communicating sipes 12 are alternately arranged in the tire circumferential direction.

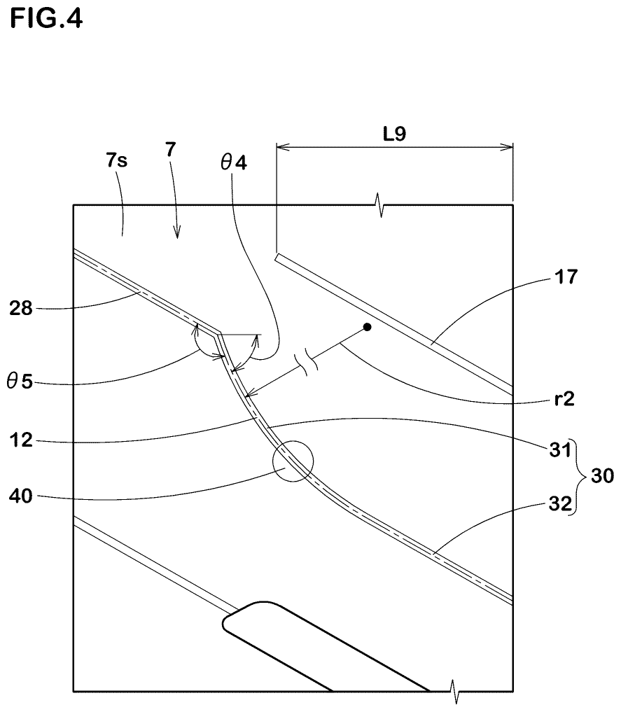

FIG. 4 shows one of the second communicating sipes 12 and its surroundings in FIG. 2.

As shown in FIGS. 2 and 4, each of the second communicating sipes 12 comprises
a second linear portion 28 extending linearly from the shoulder circumferential groove 6, and
an axially inner portion 30 extending from an axially inner end of the second linear portion 28 to the crown circumferential groove 5.

The axially inner portion 30 includes a second curved portion 31 which curves and extends from the axially inner end of the second linear portion 28.

Such second communicating sipe 12 can improve on-snow/ice performance while maintaining dry performance, similarly to the first communicating sipe 11,

The second linear portion 28 has the same features as the first linear portion 26. Therefore, the features of the first linear portion 26 described above can be applied to the second linear portion 28. Thus, the description of the second linear portion 28 is omitted here.

The second curved portion 31 is a portion of which angle θ4 with respect to the tire axial direction continuously changes from its end on the second linear portion 28 side toward the crown circumferential groove 5.

In the present embodiment, the second curved portion 31 has a shape of a circular arc with a single radius of curvature r2. But, the second curved portion 31 is not limited to such a shape.

The radius of curvature r2 is, for example, set in a range from 10 to 30 mm, preferably 15 to 25 mm.

In the present embodiment, the second communicating sipe 12 is bent at an angle θ5 between the second linear portion 28 and the second curved portion 31.

In the present embodiment, the second linear portion 28 is inclined similarly to the first linear portion 26, namely, inclined to the above-said one side in the tire circumferential direction toward the outside in the tire axial direction (inclining upward to the left in FIG. 4), and the second curved portion 31 continued therefrom is curved convexly in an oblique direction which is opposite to that of the first curved portion 27.

As a result, the angle θ4 of the second curved portion 31 with respect to the tire axial direction decreases from its axially outer end on the second linear portion 28 side toward its end on the crown circumferential groove 5 side.

The range of change of the angle θ4 is, for example, set in a range from 25 to 75 degrees. The above-mentioned angle θ5 between the second linear portion 28 and the second curved portion 31 is, for example, set in a range from 90 to 160 degrees, preferably 130 to 140 degrees.

Such second communicating sipe 12 can reliably maintain dry performance.

It is preferable that the second curved portion 31 extends across the center in the tire axial direction of the ground contacting top surface of the middle land portion 7. This makes it easier for a large ground pressure to act on the second curved portion 31. As a result, the second curved portion 31 can easily provide frictional forces in multiple directions, and the steering response on snowy and icy roads can be further improved.

In the present embodiment, the second curved portion 31 does not extend to the crown circumferential groove 5 (shown in FIG. 2). This means that the axially inner portion 30 includes a third linear portion 32 linearly extending from an axially inner end of the second curved portion 31 to the crown circumferential groove 5.

The third linear portion 32 is, for example, inclined in the same direction as the second linear portion 28, and the angular difference between them is 10 degrees or less. Preferably, the second linear portion 28 is arranged in parallel with the third linear portion 32.

The third linear portion 32 is disposed on the shoulder circumferential groove 6 side of the center in the tire axial direction of the middle land portion 7 in its entirety.

The length of the third linear portion 32 is, for example, 30% to 45% of the entire length of the second communicating sipe 12.

Such third linear portion 32 helps to improve traction performance on snowy and icy roads.

As another example, the axially inner portion 30 may be composed of only the second curved portion 31 in its entirety.

It is preferable that, as shown in FIG. 2, the dimension L5 in the tire circumferential direction of the axially inner portion 30 is smaller than
the dimension L4 in the tire circumferential direction of the axially outer portion 24.

Specifically, the dimension L4 of the axially outer portion 24 is set in a range from 50% to 100% of the distance L6 in the tire circumferential direction from the first communicating sipe 11 to the second communicating sipe 12 measured at the circumferential edge of the middle land portion 7 adjacent to the crown circumferential groove 5.

The dimension L5 of the axially inner portion 30 is set in a range from 50% to 80% of the distance L6.

Thereby, traction performance and cornering performance on snowy and icy roads can be improved in a well-balanced manner.

Next, regarding the communication sipe 10, the cross-sectional shape along the length direction will be described.

Taking the first communicating sipe 11 as an example, its shape will be described. Such description may be applied mutatis mutandis to the second communicating sipe 12.

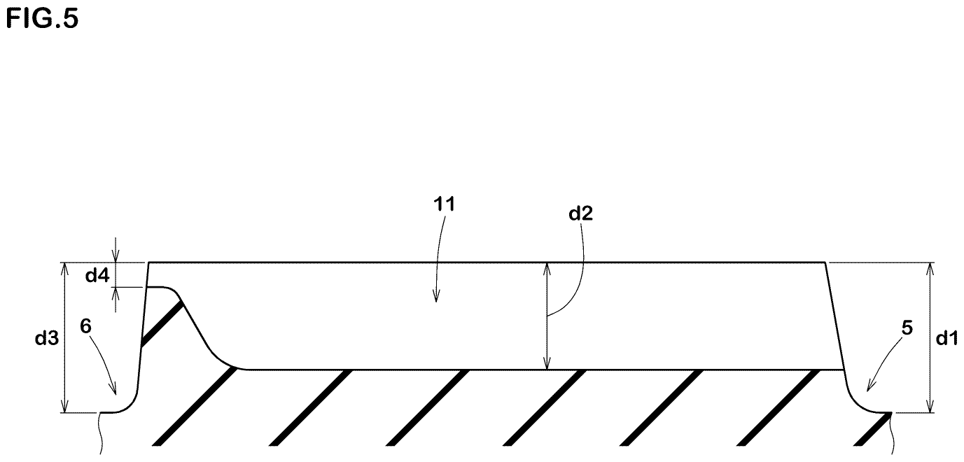

FIG. 5 shows a cross-section taken along line AA in FIG. 3.

As shown in FIG. 5, the first communicating sipe 11 extends at a constant depth d2 except for an end portion on the shoulder circumferential groove 6 side.

The depth d2 is, for example, set in a range from 80% to 95% of the maximum depth d1 of the crown circumferential groove 5.

In the first communicating sipe 11 in the present embodiment, the depth in the end portion on the shoulder circumferential groove 6 side becomes smaller toward the groove 6. And the depth d4 at the end is, for example, in a range from 20% to 35% of the maximum depth d6 of the shoulder circumferential groove 6.

This effectively maintains the rigidity of the middle land portion 7 and helps to improve dry performance.

As shown in FIG. 2, the axially inner sipes 15 include first inner sipes 16 and second inner sipes 17.

The first and second inner sipes 16 and 17 have axially outer ends on the shoulder circumferential groove 6 side which are terminated within the middle land portion and closed.

The first inner sipes 16 are inclined in the same direction as the first linear portions 26 with respect to the tire axial direction, and
the angular difference therebetween is preferably 10 degrees or less.

Preferably, the first inner sipes 16 are in parallel with the first linear portions 26.

Therefore, the angle θ7 of the first inner sipes 16 with respect to the tire axial direction is, for example, 10 to 50 degrees, preferably 25 to 35 degrees.

The first inner sipes 16, in cooperation with the first linear portions 26, help to improve traction performance on snowy and icy roads.

As shown in FIG. 3, the dimension L8 in the tire axial direction of the first inner sipe 16 is preferably larger than the dimension L3 in the tire axial direction of the first linear portion 26 when measured in the ground contacting top surface 7s of the middle land portion 7.

More specifically, the dimension L8 of the first inner sipe 16 is 35% to 50% of the width W2 (shown in FIG. 2) in the tire axial direction of the ground contacting top surface 7s of the middle land portion 7.

Such first inner sipe 16 improves dry performance and on-snow/ice performance in a well-balanced manner.

As shown in FIG. 2, in the top view of the middle land portion 7, the first inner sipe 16 at least partially overlaps with a virtual region 25 (dotted in FIG. 2) which is formed by extending the axially outer portion 24 toward the crown circumferential groove 5 in parallel to the tire axial direction, in other words, defined by a zone having a circumferential extent same as the circumferential extent (or dimension L4) of the axially outer portion 24.

It is preferable that the first inner sipe 16 is located within the virtual region 25 in its entirety.

As a result, the first inner sipe 16 and the first curved portion 27 work together to provide a large frictional force. Thereby, on-snow/ice performance can be further improved.

From the same point of view, it is preferable that the first inner sipe 16 and the axially outer portion 24 are arranged so that, in the top view of the middle land portion 7, the entire first inner sipe 16 and an end part on the shoulder circumferential groove 6 side of the axially outer portion 24 are located within a virtual zone 29 (dotted in FIG. 2) which is defined as extending in parallel to the first inner sipe 16 with a constant width W3 of less than 10 mm.

With regard to the inclination angle and direction with respect to the tire axial direction, the second inner sipe 17 has the same features as the first inner sipe 16, therefore, the features of the first inner sipe 16 described above can be applied to the second inner sipe 17.

The dimension L9 in the tire axial direction (shown in FIG. 4) of the second inner sipe 17 is larger than the dimension L3 in the tire axial direction (shown in FIG. 3) of the first linear portion 26.

The dimension L9 of the second inner sipe 17 is larger than the dimension L8 (shown in FIG. 3) of the first inner sipe 16.

More specifically, the dimension L9 of the second inner sipe 17 is 60% to 75% of the width W2 in the tire axial direction (shown in FIG. 2) of the ground contacting top surface 7s of the middle land portion 7.

Such second inner sipe 17 improves dry performance and on-snow/ice performance in a well-balanced manner.

As shown in FIG. 2, in the top view of the middle land portion 7, the second inner sipe 17 at least partially overlaps with a virtual region 33 (dotted in FIG. 2) which is formed by extending the axially inner portion 30 of the second communicating sipe 12 toward the crown circumferential groove 5 in parallel to the tire axial direction. It is preferable that 10% to 50% of the total length of the second inner sipe 17 overlaps with the virtual region 33.

As a result, the second inner sipe 17 and the axially inner portion 30 work together to provide a large frictional force, and on-snow/ice performance can be further improved.

The axially outer sipes 20 include first outer sipes 21 and second outer sipes 22. The first outer sipe 21 has a closed end on the crown circumferential groove 5 side. The second outer sipe 22 has an end on the crown circumferential groove 5 side which communicates with the after-mentioned first middle lateral groove 36.

With regard to the inclination angle and direction with respect to the tire axial direction, the first outer sipe 21 and the second outer sipe 22 each have the same features as the first inner sipe 16, therefore, the features of the first inner sipe 16 described above can be applied to the first outer sipe 21 and the second outer sipe 22.

When measured in the ground contacting top surface 7s of the middle land portion 7, the dimension L10 in the tire axial direction (shown in FIG. 3) of the first outer sipe 21 is 35% to 50% of
the maximum width W2 in the tire axial direction (shown in FIG. 2) of the ground contacting top surface 7s of the middle land portion 7.

The first outer sipe 21 is however, not limited to such configuration.

In the top view of the middle land portion 7, the first outer sipe 21 at least partially overlaps with a virtual region 34 (dotted in FIG. 3) which is formed by extending the axially outer portion 24 toward the shoulder circumferential groove 6 in parallel to the tire axial direction.

It is preferable that the first outer sipe 21 is located within the virtual region 34 in its entirety.

As a result, the first outer sipe 21 and the axially outer portion 24 cooperate to provide a large frictional force.

The middle land portion 7 is provided with a plurality of middle lateral grooves 35. The middle lateral grooves 35 include first middle lateral grooves 36 and second middle lateral grooves 37.

The first middle lateral groove 36 communicates with the crown circumferential groove 5 and extends in the tire axial direction, but does not communicate with the shoulder circumferential groove 6.

The second middle lateral groove 37 communicates with the shoulder circumferential groove 6 and extends in the tire axial direction, but does not communicate with the crown circumferential groove 5.

In the middle land portion 7 in the present embodiment, the first middle lateral grooves 36 and the second middle lateral grooves 37 are alternately arranged in the tire circumferential direction.

With regard to the inclination angle and direction with respect to the tire axial direction, the first middle lateral groove 36 and the second middle lateral groove 37 have the same features as the first inner sipe 16, therefore, the above-described features of the first inner sipe 16 can be applied to the first middle lateral groove 36 and the second middle lateral groove 37.

Each of the first middle lateral grooves 36 extends across the center in the tire axial direction of the ground contacting top surface of the middle land portion 7, and communicates with one of the second outer sipes 22.

The dimension L11 in the tire axial direction of the first middle lateral groove 36 is larger than the dimension L3 in the tire axial direction (shown in FIG. 3) of the first linear portion 26 of the first communicating sipe 11 and
larger than the dimension L8 in the tire axial direction (shown in FIG. 3) of the first inner sipe 16.

Such first middle lateral groove 36 helps to improve on-snow/ice performance while maintaining dry performance.

In the present embodiment, one of the edges of the first middle lateral groove 36 on the above-said one side in the tire circumferential direction (upper side in FIG. 2) is made up of
a major part extending substantially linearly along the longitudinal direction of the first middle lateral groove 36, and
a minor part extending linearly from the major part to the crown circumferential groove 5 at an obtuse angle with respect to the major part.

The minor part forms an upper side (edge) of a chamfer which is a triangle when viewed in the top view of the middle land portion 7.

And the other of the edges of the first middle lateral groove 36 on the other side in the tire circumferential direction (lower side in FIG. 2) is made up
a major part extending substantially linearly along the longitudinal direction of the first middle lateral groove 36, and
a minor part extending from the major part to the crown circumferential groove 5 while curving toward the other side in the tire circumferential direction, and increasing the groove width.

As a result, the first middle lateral groove 36 comprises a constant width portion 36a extending with a constant groove width, and a widened end portion 36b extending while increasing the groove width toward the crown circumferential groove 5.

Such first middle lateral groove 36 makes it easier to discharge ice and snow packed into the groove during running on snowy and icy roads, which makes it possible to continuously exhibit excellent on-snow/ice performance.

The second middle lateral groove 37 has a shape which is point symmetrical to the first middle lateral groove 36. Therefore, the features of the first middle lateral groove 36 described above can be applied mutatis mutandis to the second middle lateral groove 37.

In the present embodiment, the middle land portion 7 is provided with circular recesses 40 which open in the ground contacting top surface 7s.

The diameter of each circular recess 40 is, for example, 1.5 to 2.5 mm.

The depth of each circular recess 40 is, for example, 1.0 to 2.0 mm.

In this example, the circular recesses 40 include those respectively connected to the first curved portions 27 of the first communicating sipes 11, and those respectively connected to the second curved portions 31 of the second communicating sipes 12.

Such circular recesses 40 can provide multidirectional frictional forces and further enhance on-snow/ice performance.

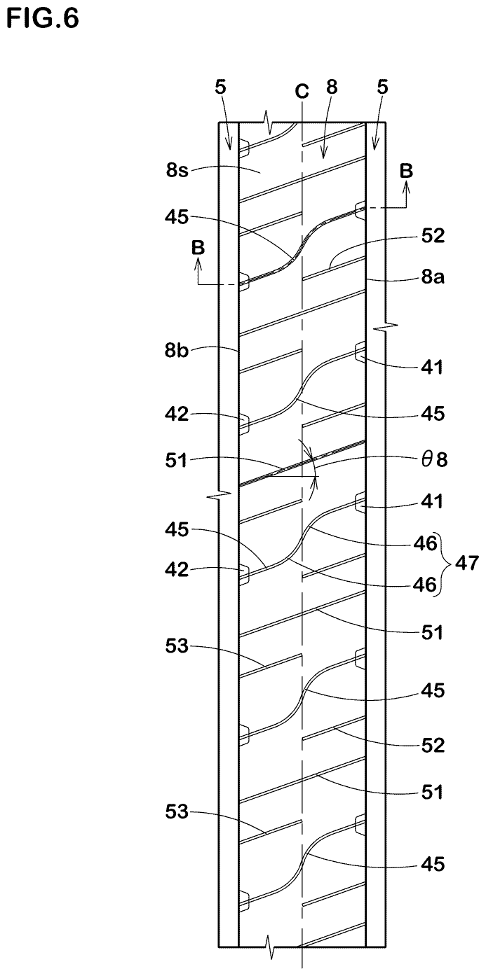

FIG. 6 is a partial top of the crown land portion 8 of the tire shown in FIG. 1. The crown land portion 8 has
a ground contacting top surface 8s defined between the two crown circumferential grooves 5,
a first side surface 8a on one side in the tire axial direction, and
a second side surface 8b on the other side in the tire axial direction.

The crown land portion 8 is provided with a plurality of first recesses 41, a plurality of second recesses 42, and a plurality of crown communicating sipes 45.

The first recess 41 is opened at the ground contacting top surface 8s and the first side surface 8a.

The second recess 42 is opened at the ground contacting top surface 8s and the second side surface 8b.

The crown communicating sipes 45 each extend in the ground contacting top surface 8s from one of the first recesses 41 to one of the second recesses 42.

Such first recesses 41, second recesses 42 and crown communicating sipes 45 help to improve on-snow/ice performance.

Each of the crown communicating sipes 45 is arranged so that an imaginary straight line (not shown) drawn between both ends of the crown communicating sipe 45 inclines in the opposite direction to the axially inner sipe 15 (shown in FIG. 2) (namely, inclines upward to the right in FIG. 6).

The crown communicating sipe 45 comprises
an S-shaped portion 47 in which two circular arc portions 46 convex in opposite directions are connected,
a first linear portion extending linearly from one of the ends of the S-shaped portion 47 to the first recess 41, and
a second linear portion extending linearly from the other of the ends of the S-shaped portion 47 to the second recess 42.

Such crown communicating sipe 45 can prevent shear deformation of the crown land portion 8 when the two sipe walls come into contact with each other, and can effectively maintain dry performance.

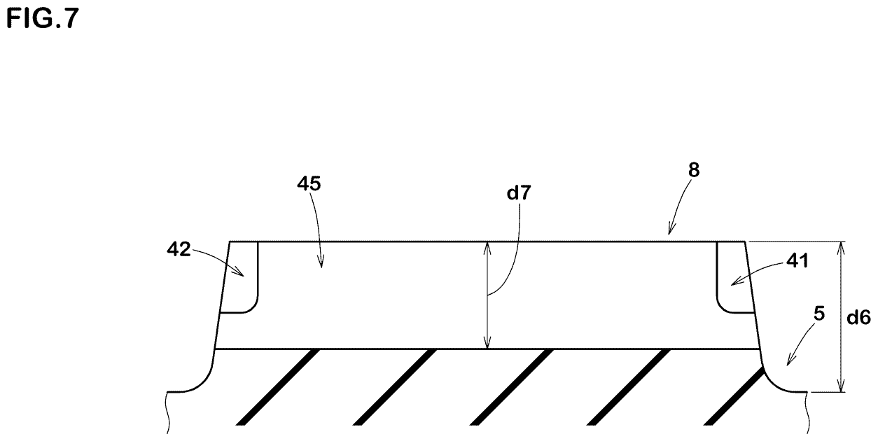

FIG. 7 shows a cross section taken along line B-B in FIG. 6.

As shown in FIG. 7, the crown communicating sipe 45 has a greater depth than those of the first and second recesses 41 and 42.

The crown communicating sipe 45 has a constant depth d7 over its entire length.

The depth d7 is, for example, 65% to 80% of the maximum depth d6 of the crown circumferential grooves 5.

Such crown communicating sipes 45 help to improve the balance between dry performance and on-snow/ice performance.

As shown in FIG. 6, the crown land portion 8 is provided with linearly-extending crown sipes which include a plurality of first crown sipes 51, a plurality of second crown sipes 52, and a plurality of third crown sipes 53.

Each of the first crown sipes 51 extends from one of the crown circumferential grooves 5 to the other of the crown circumferential grooves 5.

Each of the second crown sipes 52 extends from one of the crown circumferential grooves 5 and terminates to have a closed end within the ground contacting top surface 8s.

Each of the third crown sipes 53 extends from the other if the crown circumferential grooves 5 and terminates to have a closed end within the ground contacting top surface 8s.

The second crown sipes 52 and third crown sipes 53 extend at least to the center in the tire axial direction of the crown land portion 8.

Such sipe arrangement reliably improves on-snow/ice performance.

The first crown sipes 51, second crown sipes 52 and third crown sipes 53 are each inclined in the opposite direction to the axially inner sipe 15 (shown in FIG. 2) (namely, inclined upward to the right in FIG. 6).

The angles θ8 of the sipes 51, 52 and 53 with respect to the tire axial direction are, for example, set in a range from 20 to 30 degrees.

Such sipe arrangement improves traction performance and cornering performance on snowy and icy roads in a well-balanced manner.

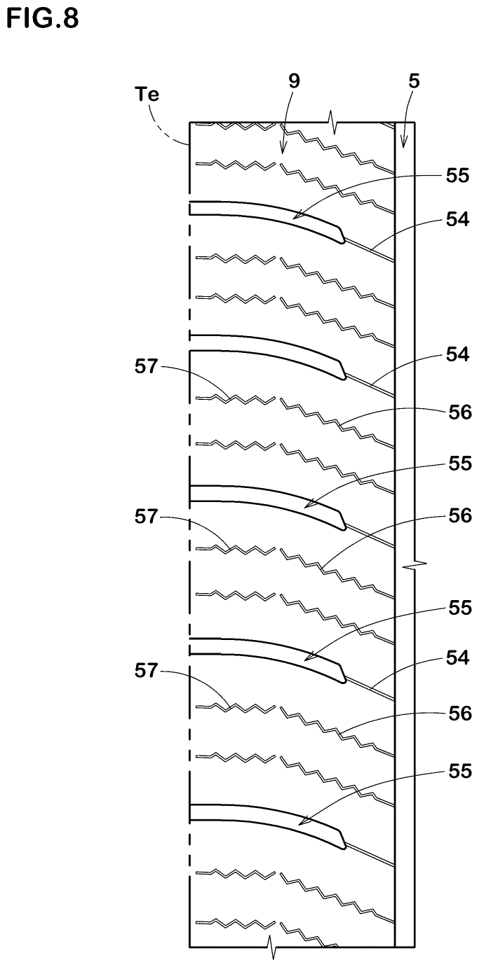

FIG. 8 is a partial top view of the shoulder land portion 9 on the left side in FIG. 1. As the shoulder land portion 9 on the right side is point symmetrical, the following description can be applied mutatis mutandis thereto.

As shown in FIG. 8, the shoulder land portion 9 is provided with a plurality of communicating sipes 54, a plurality of shoulder lateral grooves 55, a plurality of first shoulder sipes 56, and a plurality of second shoulder sipes 57.

Each of the communicating sipes 54 extends from the shoulder circumferential groove 6 and is terminated to have an axially outer end within the shoulder land portion 9.

Each of the shoulder lateral grooves 55 extends from the axially outer end of the communicating sipe 54 to at least the tread edge Te.

Such communicating sipes 54 and shoulder lateral grooves 55 can improve wet performance while suppressing excessive decrease in rigidity of the shoulder land portion 9.

Each of the first shoulder sipes 56 extends obliquely from the shoulder circumferential groove 6 and is terminated to have an axially outer closed end within the shoulder land portion 9.

Each of the second shoulder sipes 57 extends from its axially inner closed end to at least the tread edge Te.

The axially inner closed ends of the second shoulder sipes 57 are respectively disposed axially outward of and adjacently to the axially outer closed ends of the first shoulder sipes 56, and the distances therebetween are 3 mm or less, for example.

Such sipe arrangement sipes helps to maintain the rigidity of the shoulder land portion 9.

As a modified example, one first shoulder sipe 56 and one second shoulder sipe 57 may be connected with each other to form one continuous sipe.

In the present embodiment, each of the first shoulder sipes 56 and the second shoulder sipes 57 extends zigzag in its longitudinal direction.

This allows the opposite two sipe walls of each sipe to come into contact and engage with each other, therefore, the rigidity of the shoulder land portion 9 is maintained reliably, and excellent dry performance can be exhibited.

The sipes 56 and 57 are however, not limited to such zigzag shapes. Both or one of the sipe 56 and sipe 57 may be configured as a straight sipe.

While detailed description has been made of a preferable embodiment of the present disclosure, the present disclosure can be embodied in various forms without being limited to the illustrated embodiment.

### Comparison Tests

A pneumatic tire of size 215/55R17 having the tread pattern shown in FIG. 1 was experimentally manufactured as an example tire according to the present disclosure.

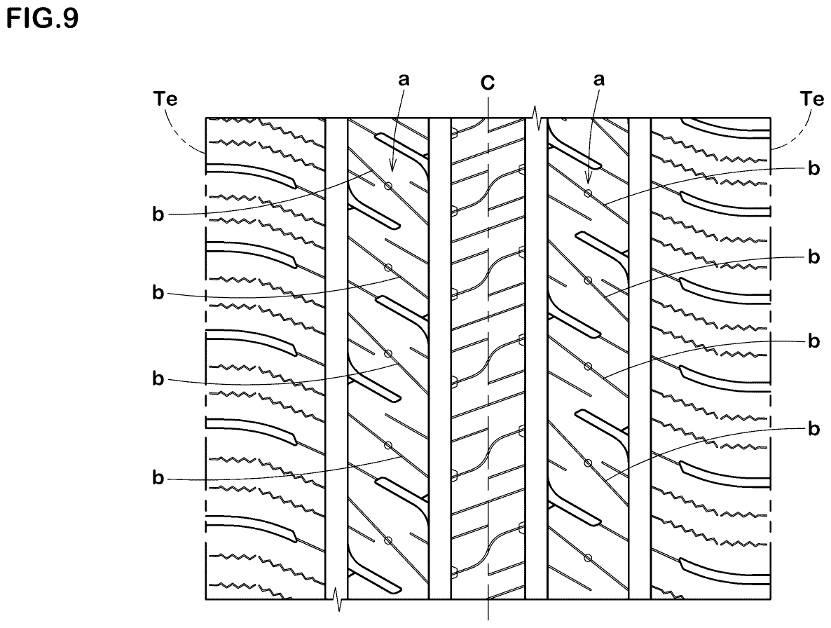

Further, as a comparative tire, a pneumatic tire of the same size having a tread pattern shown in FIG. 9 was experimentally manufactured, wherein middle land portions (a) were provided with linearly extending communicating sipes (b) as shown, instead of the first communicating sipes 11 and second communicating sipes 12, otherwise same as the example tire.

Each test tire was mounted on a wheel rim of size 17×7J and inflated to 250 kPa, and installed on all wheels of a 2500 cc front-wheel-drive test car.

Then, using the test car, the tires were tested for dry performance and on-snow/ice performance as follows.

### <Dry Performance>

During driving the test car on a dry road surface of a tire test course, driving performance was evaluated by a test driver.

The results are indicated in Table 1 by an index based on the comparative example being 100, wherein the larger the value, the better the dry performance.

### <On-Snow/Ice Performance>

During driving the test car on an icy and snowy road, driving performance was evaluated by a test driver.

The results are indicated in Table 1 by an index based on the comparative example being 100, wherein the larger the value, the better the on-snow/ice performance.

TABLE 1

| | Comparative | |
|---|---|---|
| Tire | example | Example |
| Tread pattern | FIG.9 | FIG.1 |
| Dry performance | 100 | 105 |
| On-snow/ice | 100 | 105 |
| Performance | | |

From the test results, it was confirmed that the example tire was improved in dry performance and on-snow/ice performance as compared to the comparative example tire. This show that the tire according to the present disclosure can exhibit excellent on-snow/ice performance while maintaining dry performance.

### STATEMENT OF THE PRESENT DISCLOSURE

The present disclosure is as follows.

### Present Disclosure 1

A tire (1) comprising: a tread portion (2) comprising a plurality of circumferential grooves (3) extending continuously in the tire circumferential direction, and a plurality of land portions (4) axially divided by the circumferential grooves (3), wherein
the circumferential grooves (3) include a crown circumferential groove (5), and a shoulder circumferential groove (6) disposed axially outside the crown circumferential groove (5) adjacently thereto,
the land portions (4) include a middle land portion (7) defined between the crown circumferential groove (5) and the shoulder circumferential groove (6),
the middle land portion (7) is provided with
a plurality of communicating sipes (10) extending from the crown circumferential groove (5) to the shoulder circumferential groove (6),
a plurality of axially inner sipes (15) extending axially outwards from the crown circumferential groove (5) and terminated without reaching the shoulder circumferential groove (6), and
a plurality of axially outer sipes (20) extending axially inwards from the shoulder circumferential groove (6) and terminated without reaching the crown circumferential groove (5), and
the communicating sipes (10) include a plurality of first communicating sipes (11), each of the first communicating sipes (11) comprising
a first linear portion (26) extending linearly axially outward from the crown circumferential groove (5), and
a first curved portion (27) extending curvedly from an axially outer end of the first linear portion (26) toward the shoulder circumferential groove (6).

### Present Disclosure 2

The tire according to Present Disclosure 1, wherein
the communicating sipes (10) include a plurality of second communicating sipes (12), each of the second communicating sipes (12) comprises
a second linear portion (28) extending linearly axially inward from the shoulder circumferential groove (6), and
an axially inner portion (30) extending from an axially inner end of the second linear portion (28) to the crown circumferential groove (5), and the axially inner portion (30) includes
a second curved portion (31) which curves and extends from the axially inner end of the second linear portion (28).

### Present Disclosure 3

The tire according to Present Disclosure 2, wherein
each of the first communicating sipes (11) comprises an axially outer portion (24) extending from the axially outer end of the first linear portion (26) to the shoulder circumferential groove (6),
the axially outer portion (24) includes the above-said first curved portion (27), and a dimension (L5) in the tire circumferential direction of the axially inner portion (30) is smaller than a dimension (L4) in the tire circumferential direction of the axially outer portion (24).

### Present Disclosure 4

The tire according to Present Disclosure 2 or 3, wherein
the dimension (L4) in the tire circumferential direction of the axially outer portion (24) is 50% to 100% of a distance (L6) in the tire circumferential direction from the first communicating sipe (11) to the second communicating sipe (12) when measured at a circumferential edge of the middle land portion (7) adjacent to the crown circumferential groove (5), and the dimension (L5) in the tire circumferential direction of the axially inner portion (30) is 10% to 50% of the above-said distance (L6) in the tire circumferential direction.

### Present Disclosure 5

The tire according to any one of Present Disclosures 2 to 4, wherein
the axially inner portion (30) includes a third linear portion (32) extending linearly from an axially inner end of the second curved portion (31) to the crown circumferential groove (5).

### Present Disclosure 6

The tire according to any one of Present Disclosures 1 to 5, wherein
the first communicating sipe (11) is bent at an angle θ3 between the first linear portion (26) and the first curved portion (27).

### Present Disclosure 7

The tire according to any one of Present Disclosures 1 to 6, wherein
the first curved portion (27) extends across the center in the tire axial direction of the ground contacting top surface (7s) of the middle land portion (7).

### Present Disclosure 8

The tire according to any one of Present Disclosures 1 to 7, wherein
the axially outer sipes (20) include first outer sipes (21) whose ends on the crown circumferential groove side are closed, and
in a top view of the middle land portion (7), each first outer sipe (21) is disposed within a virtual region which is formed by extending one of the first curved portions (27) toward the shoulder circumferential groove (6) in parallel to the tire axial direction.

### Present Disclosure 9

The tire according to any one of Present Disclosures 1 to 8, wherein
the axially inner sipes (15) include first inner sipes (16) whose ends on the shoulder circumferential groove side are closed, and
in a top view of the middle land portion (7), each first inner sipe (16) is disposed within a virtual region which is formed by extending one of the first curved portions (27) toward the crown circumferential groove (5) in parallel to the tire axial direction.

### Present Disclosure 10

The tire according to Present Disclosure 9, wherein
the axially inner sipes (15) include second inner sipes (17) whose ends on the shoulder circumferential groove side are closed, and
a dimension (L9) in the tire axial direction of the second inner sipe (17) is greater than a dimension (L8) in the tire axial direction of the first inner sipe (16).

### Present Disclosure 11

The tire according to any one of Present Disclosures 1 to 10, wherein
the land portions (4) include a single crown land portion (8) defined between two crown circumferential grooves (5) which are disposed one on each side of the tire equator (C), the crown land portion (8) has a ground contacting top surface (8s) defined between the two crown circumferential grooves (5), a first side surface (8a) on one side in the tire axial direction, and a second side surface (8b) on the other side in the tire axial direction, the crown land portion (8) is provided with
a plurality of first recesses (41) opening in the ground contacting top surface (8s) and the first side surface (8a);
a plurality of second recesses (42) opening in the ground contacting top surface (8s) and the second side surface (8b); and
a plurality of crown communicating sipes (45) extending from the first recesses (41) to the second recesses (42).

### Present Disclosure 12

The tire according to Present Disclosure 11, wherein
each of the crown communicating sipes (45) comprises an S-shaped portion (47) in which two circular arc portions convex in opposite directions are connected.

### DESCRIPTION OF THE REFERENCE SIGNS

2 tread portion
3 circumferential groove
4 land portion
5 crown circumferential groove
6 shoulder circumferential groove
7 middle land portion
10 communicating sipe
11 first communicating sipe
15 axially inner sipe
20 axially outer sipe
26 first linear portion
27 first curved portion

1. A tire comprising:
a tread portion comprising
a plurality of circumferential grooves extending continuously in the tire circumferential direction, and
a plurality of land portions axially divided by the circumferential grooves, wherein
the circumferential grooves include
a crown circumferential groove, and
a shoulder circumferential groove disposed axially outside the crown circumferential groove adjacently thereto,
the land portions include
a middle land portion defined between the crown circumferential groove and the shoulder circumferential groove,
the middle land portion is provided with
a plurality of communicating sipes extending from the crown circumferential groove to the shoulder circumferential groove,
a plurality of axially inner sipes extending axially outwards from the crown circumferential groove and terminated without reaching the shoulder circumferential groove, and a plurality of axially outer sipes extending axially inwards from the shoulder circumferential groove and terminated without reaching the crown circumferential groove, and
the communicating sipes include a plurality of first communicating sipes, each of the first communicating sipes comprising
a first linear portion extending linearly axially outward from the crown circumferential groove, and
a first curved portion extending curvedly from an axially outer end of the first linear portion toward the shoulder circumferential groove.

2. The tire according to claim 1, wherein
the communicating sipes include a plurality of second communicating sipes,
each of the second communicating sipes comprises
a second linear portion extending linearly axially inward from the shoulder circumferential groove, and
an axially inner portion extending from an axially inner end of the second linear portion to the crown circumferential groove, and
the axially inner portion includes a second curved portion which curves and extends from the axially inner end of the second linear portion.

3. The tire according to claim 2, wherein
each of the first communicating sipes comprises
an axially outer portion extending from the axially outer end of the first linear portion to the shoulder circumferential groove,
the axially outer portion includes the above-said first curved portion, and
a dimension (L5) in the tire circumferential direction of the axially inner portion is smaller than a dimension (L4) in the tire circumferential direction of the axially outer portion.

4. The tire according to claim 3, wherein
in the middle land portion, the first communicating sipes and the second communicating sipes are alternately arranged in the tire circumferential direction, and
the first curved portion of each first communicating sipe is convex toward an oblique direction with respect to the tire axial direction the second curved portion of each second communicating sipe is convex toward an oblique direction with respect to the tire axial direction which is opposite to that of the first curved portion.

5. The tire according to claim 3, wherein
the dimension (L4) in the tire circumferential direction of the axially outer portion is 50% to 100% of a distance (L6) in the tire circumferential direction from the first communicating sipe to the second communicating sipe when measured at a circumferential edge of the middle land portion adjacent to the crown circumferential groove, and
the dimension (L5) in the tire circumferential direction of the axially inner portion is 10% to 50% of the above-said distance (L6) in the tire circumferential direction.

6. The tire according to claim 5, wherein
in the middle land portion, the first communicating sipes and the second communicating sipes are alternately arranged in the tire circumferential direction, and
the first curved portion of each first communicating sipe is convex toward an oblique direction with respect to the tire axial direction the second curved portion of each second communicating sipe is convex toward an oblique direction with respect to the tire axial direction which is opposite to that of the first curved portion.

7. The tire according to claim 5, wherein
the axially inner portion includes a third linear portion extending linearly from an axially inner end of the second curved portion to the crown circumferential groove.

8. The tire according to claim 7, wherein
in the middle land portion, the first communicating sipes and the second communicating sipes are alternately arranged in the tire circumferential direction, and
the first curved portion of each first communicating sipe is convex toward an oblique direction with respect to the tire axial direction the second curved portion of each second communicating sipe is convex toward an oblique direction with respect to the tire axial direction which is opposite to that of the first curved portion.

9. The tire according to claim 7, wherein
the first communicating sipe is bent at an angle θ3 between the first linear portion and the first curved portion.

10. The tire according to claim 1, wherein
the first curved portion extends across the center in the tire axial direction of the ground contacting top surface of the middle land portion.

11. The tire according to claim 1, wherein
the axially outer sipes include first outer sipes whose ends on the crown circumferential groove side are closed, and
in a top view of the middle land portion, each first outer sipe is disposed within a virtual region which is formed by extending one of the first curved portions toward the shoulder circumferential groove in parallel to the tire axial direction.

12. The tire according to claim 1, wherein
the axially inner sipes include first inner sipes whose ends on the shoulder circumferential groove side are closed, and
in a top view of the middle land portion, each first inner sipe is disposed within a virtual region which is formed by extending one of the first curved portions toward the crown circumferential groove in parallel to the tire axial direction.

13. The tire according to claim 11, wherein
the axially inner sipes include first inner sipes whose ends on the shoulder circumferential groove side are closed, and
in a top view of the middle land portion, each first inner sipe is disposed within a virtual region which is formed by extending one of the first curved portions toward the crown circumferential groove in parallel to the tire axial direction.

14. The tire according to claim 12, wherein
the axially inner sipes include second inner sipes whose ends on the shoulder circumferential groove side are closed, and
a dimension (L9) in the tire axial direction of the second inner sipe is greater than a dimension (L8) in the tire axial direction of the first inner sipe.

15. The tire according to claim 13, wherein
the axially inner sipes include second inner sipes whose ends on the shoulder circumferential groove side are closed, and
a dimension (L9) in the tire axial direction of the second inner sipe is greater than a dimension (L8) in the tire axial direction of the first inner sipe.

16. The tire according to claim 1, wherein
the land portions include a single crown land portion defined between two crown circumferential grooves which are disposed one on each side of the tire equator (C),
the crown land portion has
a ground contacting top surface defined between the two crown circumferential grooves,
a first side surface on one side in the tire axial direction, and
a second side surface on the other side in the tire axial direction, and
the crown land portion is provided with
a plurality of first recesses opening in the ground contacting top surface and the first side surface;
a plurality of second recesses opening in the ground contacting top surface and the second side surface; and
a plurality of crown communicating sipes extending from the first recesses to the second recesses.

17. The tire according to claim 6, wherein
the land portions include a single crown land portion defined between two crown circumferential grooves which are disposed one on each side of the tire equator (C),
the crown land portion has
a ground contacting top surface defined between the two crown circumferential grooves,
a first side surface on one side in the tire axial direction, and
a second side surface on the other side in the tire axial direction, and
the crown land portion is provided with
a plurality of first recesses opening in the ground contacting top surface and the first side surface;
a plurality of second recesses opening in the ground contacting top surface and the second side surface; and
a plurality of crown communicating sipes extending from the first recesses to the second recesses.

18. The tire according to claim 8, wherein
the land portions include a single crown land portion defined between two crown circumferential grooves which are disposed one on each side of the tire equator (C),
the crown land portion has
a ground contacting top surface defined between the two crown circumferential grooves,
a first side surface on one side in the tire axial direction, and
a second side surface on the other side in the tire axial direction, and
the crown land portion is provided with
a plurality of first recesses opening in the ground contacting top surface and the first side surface;
a plurality of second recesses opening in the ground contacting top surface and the second side surface; and
a plurality of crown communicating sipes extending from the first recesses to the second recesses.

19. The tire according to claim 16, wherein
each of the crown communicating sipes comprises
an S-shaped portion in which two circular arc portions convex in opposite directions are connected.

20. The tire according to claim 18, wherein
each of the crown communicating sipes comprises
an S-shaped portion in which two circular arc portions convex in opposite directions are connected.
